(19) United States
(12) Patent Application Publication
(10) Pub. No.: US 2003/0015330 A1
(43) Pub. Date: Jan. 23, 2003

(54) Utility wildlife protector and associated methods

(75) Inventors: Eugene H. Wood, Hickory, NC (US); Michael G. Nolte, Hickory, NC (US); David A. Franklin, Morganton, NC (US)

Correspondence Address: JEFFREY S. WHITTLE, ESQUIRE, bracewell & patterson llp, 711 louisana street, houston, TX, 77002, US

(73) Assignee: Utility Solutions, Inc.

(21) Appl. No.: 10/001,247

(22) Filed: Nov. 1, 2001

Related U.S. Application Data
(60) Provisional application No. 60/306,918, filed on Jul. 20, 2001.

(51) Int. Cl. H01B 1/00

(52) U.S. Cl. 174/5 R

(57) ABSTRACT

A utility wildlife protection system is provided including a utility wildlife protector and an installation tool. The utility wildlife protector preferably includes a pair of pivotally connected wildlife guards and a pivot connecting member that can be engaged by an installation tool so that installation can be achieved by a single installer from a great distance away from high voltage equipment to reduce the risk of contacting high voltage equipment.

### RELATED APPLICATIONS

The present application claims the benefit of Provisional Patent Application Serial No. 60/306,918, filed on Jul. 20, 2001, titled, Utility Wildlife Protector and Associated Methods which is incorporated herein in its entirety by reference.

### FIELD OF THE INVENTION

The present invention relates to the field of high voltage equipment and, more particularly, the protection of high voltage equipment from damage caused by intrusion of wildlife.

### BACKGROUND OF THE INVENTION

Wildlife, such as snakes, squirrels, birds, raccoons, and vermin in general, routinely moves across high voltage equipment and distribution lines. Damage to high voltage equipment can occur if the wildlife makes simultaneous contact with the high voltage equipment, e.g., an insulator, and an electrical ground. The damage can include electrical service outage, high voltage equipment damage, and death to the intruding wildlife.

Wildlife guards are generally known and used to minimize or prevent damage to high voltage equipment and death of wildlife that intrude on high voltage equipment. For example, as shown in U.S. Pat. No. 5,864,096 titled Wildlife Guard For Electrical Power Distribution and Substitution Facilities by Williams, these wildlife guards act as physical barriers positioned around a bushing, or other high voltage equipment, and between an area of exposed high voltage and an electrical ground. Although these wildlife guards make it extremely difficult, if not impossible, for wildlife to simultaneously contact both exposed high voltage equipment and an electrical ground, they can sometimes be difficult to install and uninstall. For example, to install the wildlife guard described in Williams '096, the teeth positioned about the center portion of the wildlife guard must be accurately aligned with the bushing of the high voltage equipment. The wildlife protector described in Williams '096 can also be cumbersome and difficult to transport. The size and shape of the wildlife protector described in Williams '096 also disadvantageously increases the amount of space necessary to store a plurality of wildlife protectors.

Other generally known wildlife guards are disadvantageous because they also require complicated and sometimes dangerous installation. For example, in order to install the generally known wildlife guards, an installer, normally an electrical utility lineman, must have access to the high voltage area to be protected. To provide the lineman with access to the high voltage area to be protected, electrical service normally must be interrupted. Further, the installation of the generally known wildlife protectors are time consuming and can be labor intensive. Alternatively, installation of the generally known wildlife protectors can be accomplished without the interruption of electrical service, but at a great risk to the installer. The installer must come in dangerous proximity to an active, or “hot”, high voltage source in order to install the wildlife protectors. When working in dangerous proximity to high voltage equipment, a great deal of precautions must be taken to reduce the risk of installers contacting high voltage equipment. These added precautions can be time consuming. If the added precautions are not taken, however, serious injury can result to the installer.

Current wildlife protectors can also be disadvantageous because they can sometimes have a predetermined size to fit on a predetermined piece of high voltage equipment. Therefore, if a lineman encounters various sized pieces of high voltage equipment, the lineman must have various sized wildlife protectors. To avoid this, a lineman must carry a plurality of various sized wildlife protectors at all times so as to have the ability to install a wildlife protector on a piece of high voltage equipment, regardless of the size.

Another problem that can exist with current wildlife protectors is that it can require two linemen to install the wildlife protector in the area having the high voltage equipment, thereby making the installation labor intensive. This process, therefore, greatly increases labor costs and decreases time efficiency of the installers or linemen.

### SUMMARY OF THE INVENTION

With the foregoing in mind, the present invention advantageously provides a utility wildlife protection system, a utility wildlife protector, methods of inhibiting wildlife from simultaneously contacting high voltage equipment and an electrical ground, and methods of installing a utility wildlife protector that allows for a utility wildlife protector to be installed on high voltage equipment from a distance where an installer is not likely to simultaneously contact high voltage equipment and an electrical ground. An elongate installation tool can advantageously be used to open a portion of the utility wildlife protector of the present invention, position the utility wildlife protector about portions of high voltage equipment so as to form a barrier between the high voltage equipment and an electrical ground, and secure the utility wildlife protector about portions of high voltage equipment. This advantageously enhances the distance between an installer and high voltage equipment during installation. The system also advantageously provides a time efficient and cost-effective way to install wildlife protectors about portions of high voltage equipment. The system of the present invention advantageously eliminates installer contact with high voltage equipment during installation of wildlife guards. The system of the present invention also advantageously decreases the time necessary to install a utility wildlife protector to provide a barrier between high voltage equipment and an electrical ground. The utility wildlife protection system of the present invention further advantageously decreases the danger of wildlife simultaneously contacting high voltage equipment and an electrical ground, which causes harm, and sometimes death, to the wildlife.

More particularly, the present invention provides a utility wildlife protection system for inhibiting wildlife from simultaneously contacting high voltage equipment and an electrical ground. The utility wildlife protection system preferably includes a utility wildlife protector which advantageously has a pair of wildlife guards each having respective first and second opposing end portions and each adapted to be positioned closely adjacent an insulator of high voltage equipment along opposing portions of inner peripheries thereof. The pair of wildlife guards also have other opposing inner periphery portions positioned closely adjacent each other when the utility wildlife protector is positioned in a closed retracted position. A connector preferably is positioned to pivotally connect the respective first end portions of each of the pair of wildlife guards so that respective second opposing end portions are positioned closely adjacent each other when the utility wildlife protector is positioned in the closed retracted position and are positioned substantially spaced apart from each other when the utility wildlife protector is positioned in an open extended position.

The utility wildlife protector also advantageously includes a guard extender connected closely adjacent the respective first end portions of each of the pair of wildlife guards for increasing and decreasing a distance between the respective second end portions of the pair of wildlife guards to thereby respectively position the utility wildlife protector between the open extended position and the closed retracted position. The utility wildlife protection system of the present invention further includes an elongate installation tool having a proximal and a distal end portion. The distal end portion includes a guard extender adjuster adapted to abuttingly contact portions of the guard extender to responsively adjust the guard extender to thereby increase and decrease the distance between the respective second end portions of each of the pair of wildlife guards and respectively position the utility wildlife protector between the open extended position and the closed retracted position.

The present invention also advantageously provides a utility wildlife protector for inhibiting wildlife from simultaneously contacting elevated high voltage equipment and an electrical ground. The utility wildlife protector preferably is adapted to be positioned adjacent elevated high voltage equipment and responsive to an elongate extension tool. The utility wildlife protector preferably includes an open extended position to allow inner portions of the wildlife protector to be positioned adjacent outer peripheries of the elevated high voltage equipment, and a closed retracted position defined by the wildlife protector substantially surrounding the outer peripheries of the elevated high voltage equipment. The wildlife protector preferably is respectively extended to an open extended position and retracted to a closed retracted position responsive to movement of an elongate extension tool by a user.

The present invention further advantageously includes methods of inhibiting wildlife from simultaneously contacting high voltage equipment and an electrical ground. A method preferably includes rotating portions of a guard extender in a first predetermined direction to pivotally open portions of a utility wildlife protector to an open extended position to surround an insulator of high voltage equipment. The method preferably also includes rotating portions of the guard extender in a second predetermined direction to pivotally close portions of the utility wildlife protector to a closed retracted position. The methods of the present invention advantageously allow one installer to install the utility wildlife protector from a great distance away from high voltage equipment, i.e., from ground level if the high voltage equipment is elevated.

The present invention advantageously eliminates excess space needed to transport a plurality of wildlife protectors. The present invention also advantageously provides wildlife protectors that are light in weight so that transport and installation of the wildlife protectors is greatly simplified. The present invention further advantageously allows for a wildlife protector to be easily uninstalled, i.e., removed from high voltage equipment.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a fragmentary environmental view of a utility wildlife protection system having a utility wildlife protector in a closed retracted position according to the present invention;

FIG. 2 is a fragmentary perspective view of a utility wildlife protection system according to the present invention;

FIG. 3 is a fragmentary environmental view of a utility wildlife protection system having a utility wildlife protector in an open extended position according to the present invention;

FIG. 4 is a fragmentary perspective view of a utility wildlife protection system having a utility wildlife protector in an open extended position according to the present invention;

FIG. 5 is a perspective view of a utility wildlife protector according to the present invention;

FIG. 6 is a front elevation view of a guard extender-to-tool interface assembly of a wildlife protector according to the present invention;

FIG. 7 is a fragmentary exploded perspective of a utility wildlife protection system according to the present invention; and

FIG. 8 is a fragmentary environmental view of a utility wildlife protection system being installed by two installers according to the present invention.

### DETAILED DESCRIPTION

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art.

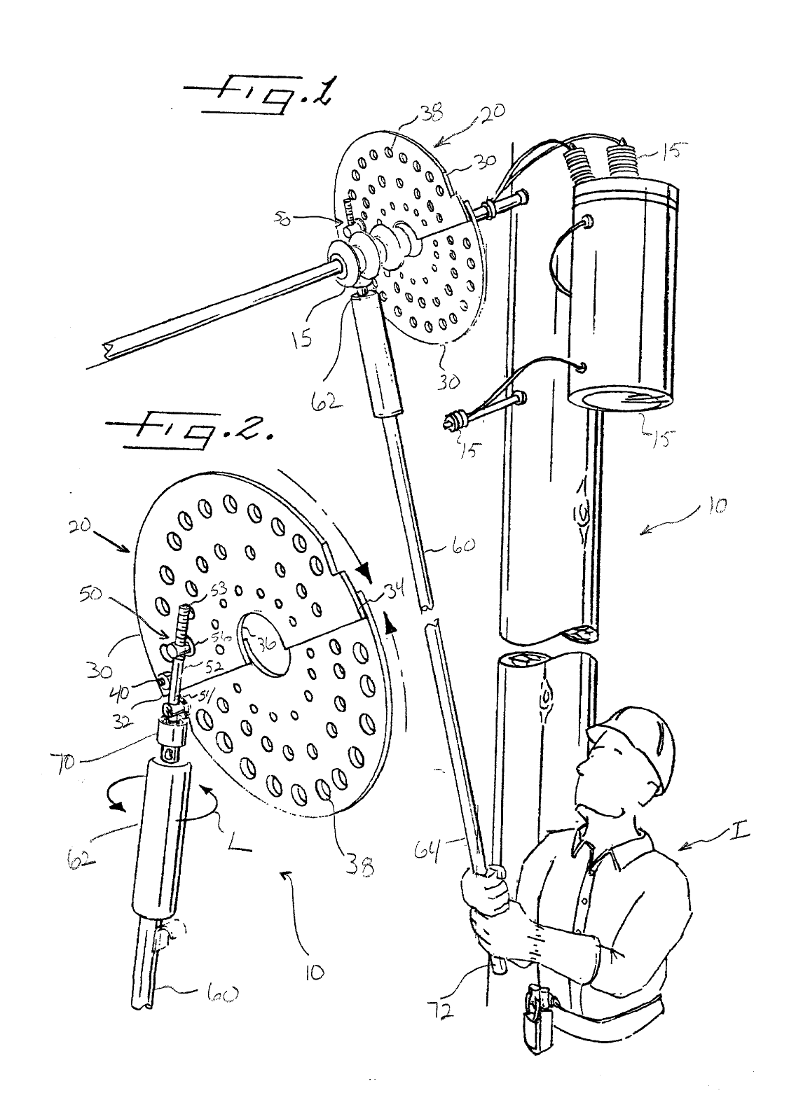

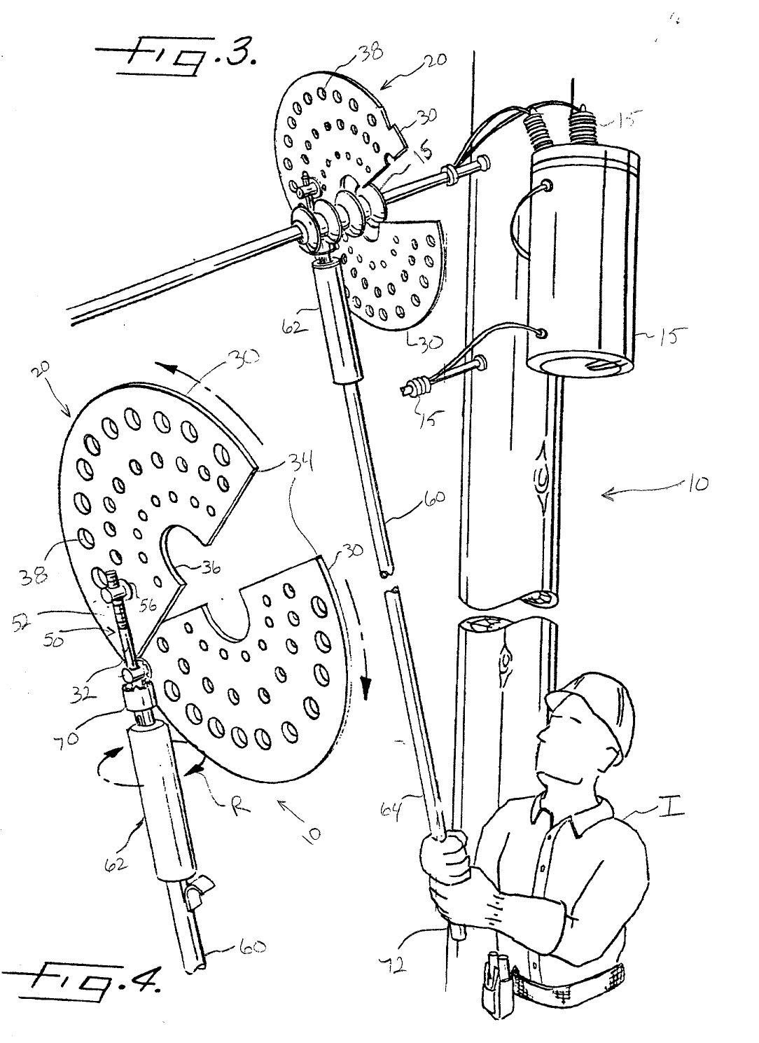

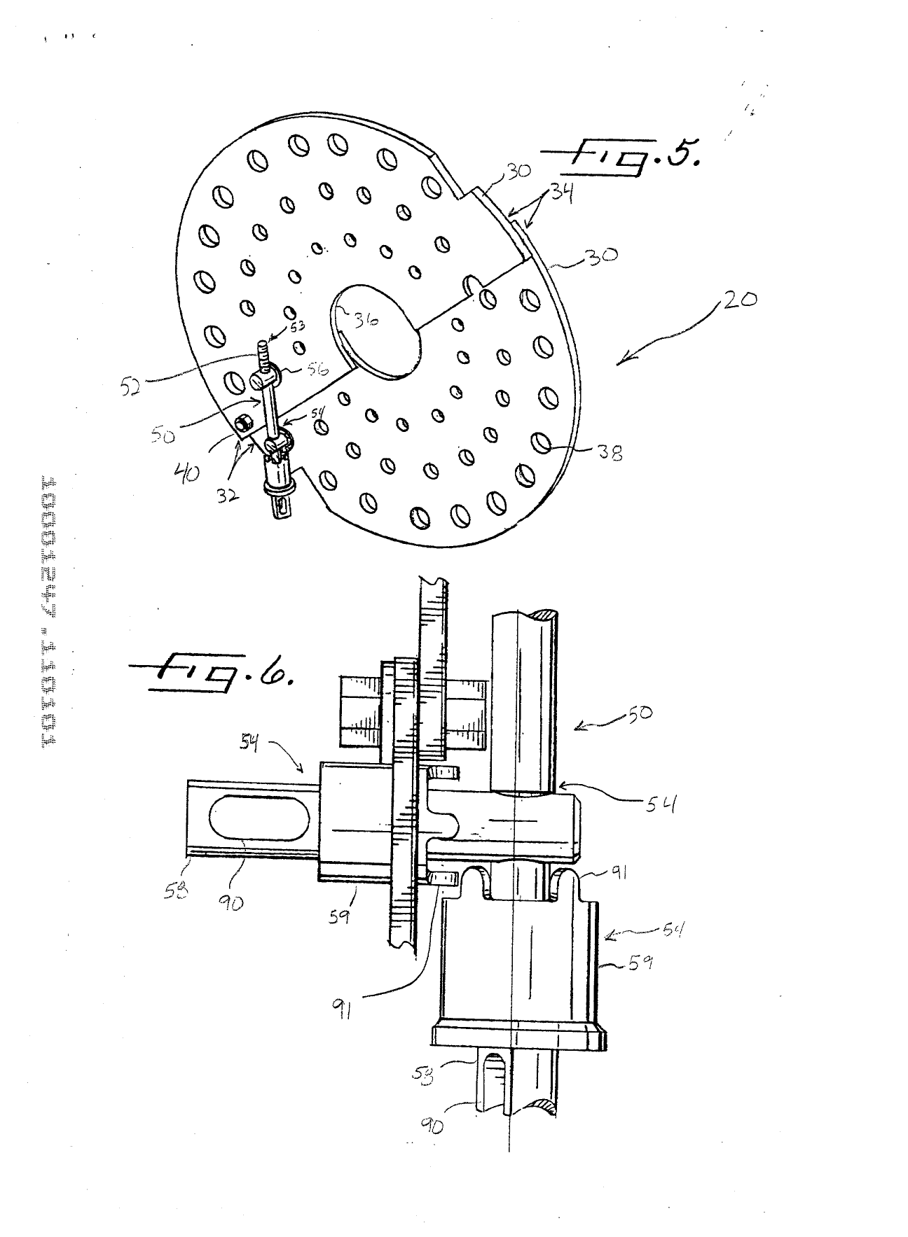

FIGS. 1-8, illustrate a utility wildlife protection system 10 according to the present invention for inhibiting wildlife from simultaneously contacting high voltage equipment 15 and an electrical ground. The utility wildlife protection system 10 of the present invention can advantageously include a utility wildlife protector 20 and an elongate installation tool 60. The utility wildlife protector 20 of the utility wildlife protection system 10 preferably includes a pair of wildlife guards 30.

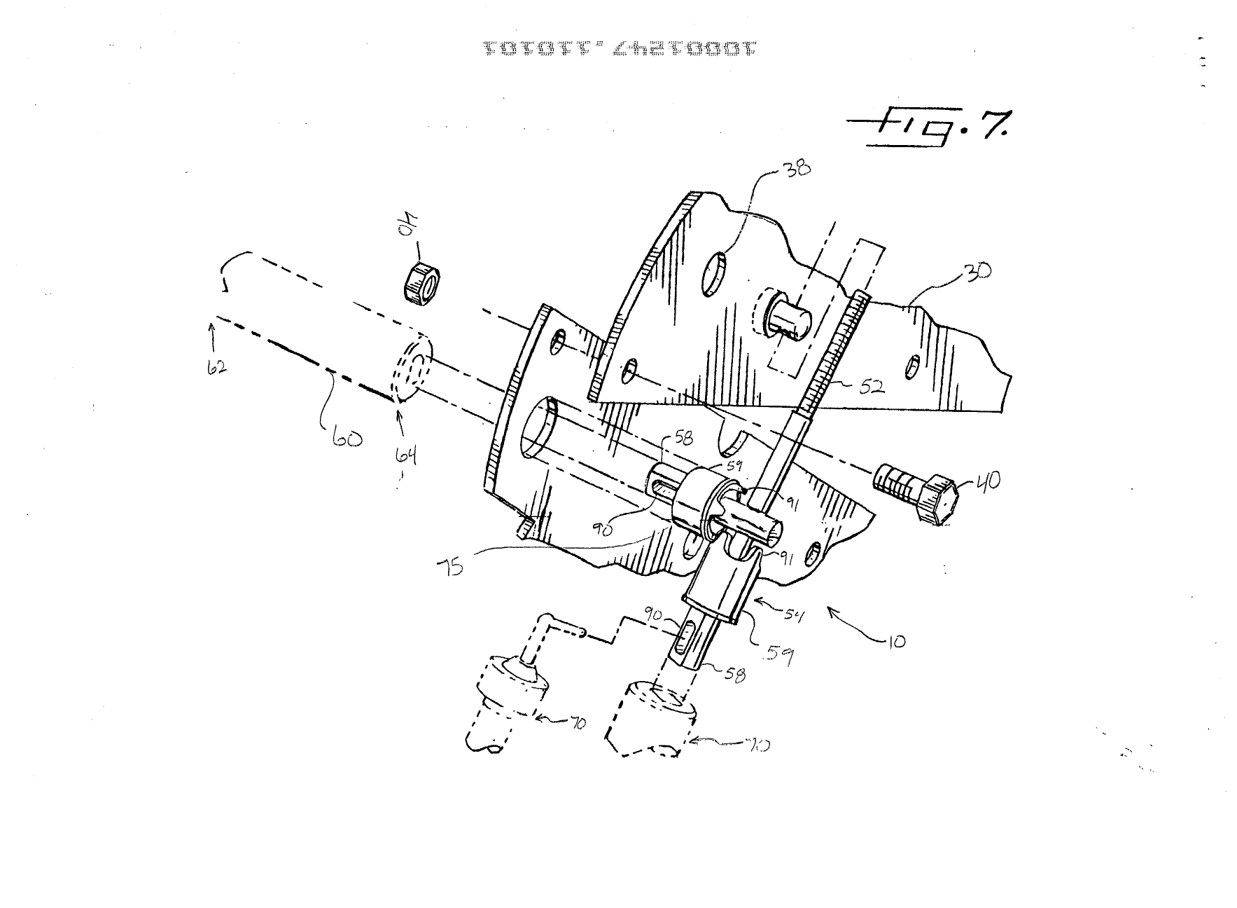

As perhaps best illustrated in FIG. 5, each of the wildlife guards 30 can advantageously include respective first 32 and second 34 opposing end portions. The respective first 32 and second 34 end portions preferably are adapted to be positioned closely adjacent high voltage equipment 15, e.g., an insulator or bushing, along portions of inner peripheries 36 thereof. The inner peripheries 36 of each of the pair of wildlife guards 30 are positioned closely adjacent each other when the utility wildlife protector 20 is positioned in a closed retracted position.

The pair of wildlife guards 30 can advantageously be pivotally connected by a connector 40. The connector 40 can advantageously be positioned to pivotally connect to the respective first end portions 32 of each of the pair of wildlife guards 30 so that the respective second opposing end portions 34 are positioned closely adjacent each other when the utility wildlife protector 20 is positioned in the closed retracted position. The second end portions 32 of each of the pair of wildlife guards 30 are positioned substantially spaced-apart from each other when the utility wildlife protector 20 is positioned in an open extended position.

The pair of wildlife guards 30 are preferably constructed of a non-conductive material, such as a thermoset polymer, but any non-conductive and lightweight material can be used to construct the wildlife guards 30 as understood by those skilled in the art. A thermoset polymer is preferably used because it is flame resistant, non-sagging, tracking resistant and inherently resistant to weathering degradation caused by rain, snow, temperature extremes and ultra violet exposures. Therefore, the pair of wildlife guards 30 are advantageously rugged so as to withstand the effects of environmental conditions.

As illustrated in FIGS. 1 and 4-5, the utility wildlife protector 20 can further advantageously include guard positioning means for positioning the utility wildlife protector 20 between an open extended position and a closed retracted position. The guard positioning means can advantageously be provided by a guard extender 50 connected closely adjacent the respective first end portions 32 of each of the pair of wildlife guards 30 for increasing and decreasing a distance between the respective second end portions 34 of each of the pair of wildlife guards 30. When the distance between the respective second end portions 34 of the pair of wildlife guards 30 is increased, the utility wildlife protector 20 is positioned in the open extended position. Similarly, when the distance between the respective second end portions 34 of each of the pair of wildlife guards 30 is decreased, the utility wildlife protector 20 is positioned in the closed retracted position. The guard extender 50 advantageously allows the utility wildlife protector 20 to be readily positioned between the open extended position and the closed retracted position.

The utility wildlife protector 20 can also advantageously include various diameters for optimal bushing spacing, and for an optimum fit on disconnect switches and power fuse mountings, for example. The utility wildlife protector 20 of the utility wildlife protection system 10 can be adapted to fit any core diameter insulator but is preferably particular for core diameters in a range from about 2.5 to about 4.5 inches in diameter. The utility wildlife protector 20 can further include a plurality of openings 38 positioned in a concentric hole design to facilitate natural rain washing action of insulator surfaces and for minimizing wind load. The concentric hole design can also advantageously minimize public visibility if a discrete color, such as grey, is chosen for the utility wildlife protector 20.

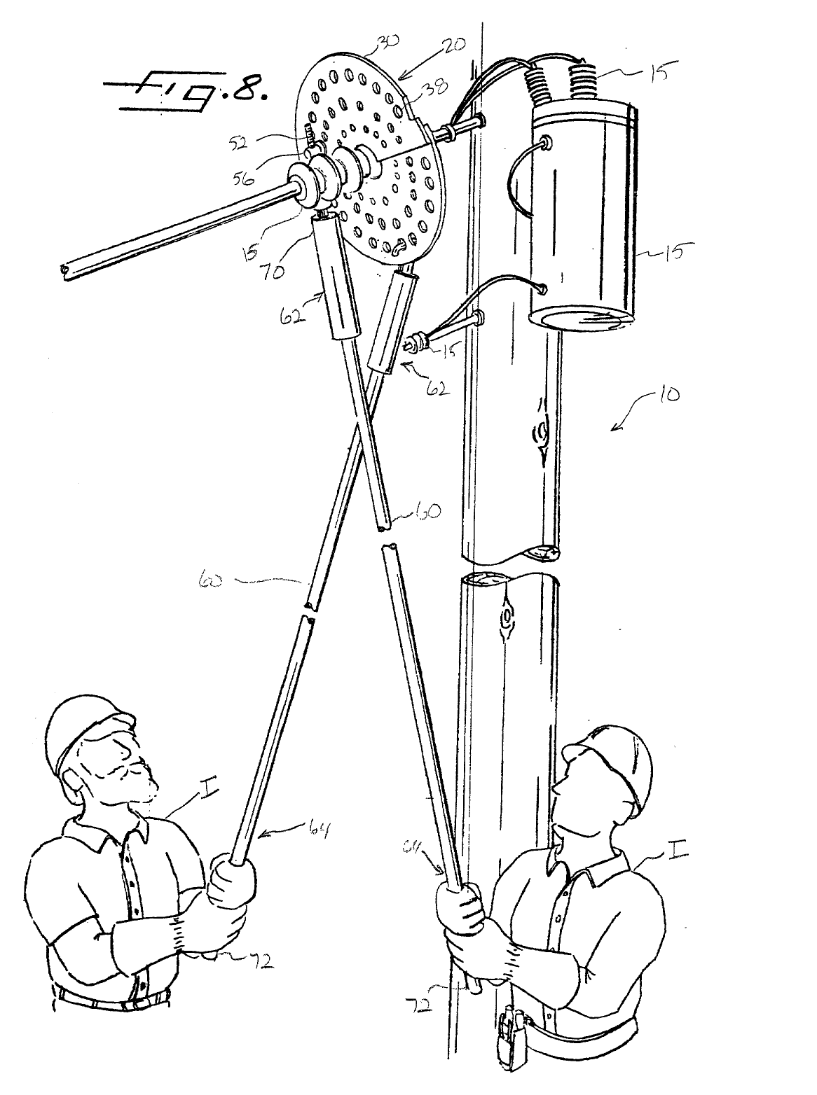

As shown in FIGS. 1, 3, and 8, the utility wildlife protection system 10 of the present invention further advantageously includes an elongate installation tool 60. The elongate installation tool 60 can advantageously include a proximal 64 and a distal 62 end portion. Guard adjusting means preferably is mounted to the distal end portion 62 for adjusting the guard extender 50 (See FIGS. 6-7). The guard adjusting means can advantageously be provided by a guard extender-to-tool interface assembly 70 adapted to abuttingly contact portions of the guard extender 50 to adjust the guard extender 50 responsive to movement of the elongate installation tool 60.

The guard extender-to-tool interface assembly 70 can advantageously be used to adjust the guard extender 50 to position the utility wildlife protector 20 in the open extended position or in the closed retracted position. The guard extender-to-tool interface assembly 70 mounted on the distal end portion 62 of the elongate installation tool 60 is preferably positioned to matingly contact the guard extender 50 positioned on the utility wildlife protector 20. The guard extender-to-tool interface assembly 70 can, for example, include a shape suitable for matingly receiving portions of the guard extender 50 to be rotated in the respective first L or second R predetermined directions. The guard extender-to-tool interface assembly 70 can also, for example, advantageously include a hook portion adapted to also engage portions of the guard extender to be rotated in the respective first L and second R predetermined directions. The guard extender-to-tool interface assembly 70 is connected to the elongate installation tool 60 so that when the installer I rotates the elongate installation tool 60 in a first predetermined direction L the guard extender-to-tool interface assembly 70 will likewise rotate in the first predetermined direction L. Therefore, when the guard extender-to-tool interface assembly 70 is rotated in the first predetermined direction L, the guard extender 50 is similarly rotated in the first predetermined direction L to thereby increase the distance between the respective second end portions 34 of each of the pair of wildlife guards 50 to position the utility wildlife protector 20 in the open extended position. Also similarly, when the installer I rotates the elongate installation tool 60 in a second predetermined direction R the guard extender-to-tool interface assembly 70 will likewise rotate in the second predetermined direction R. Therefore, when the guard extender-to-tool interface assembly 70 is rotated in the second predetermined direction R, the guard extender 50 is similarly rotated in the second predetermined direction R to thereby decrease the distance between the respective second end portions 34 of each of the pair of wildlife guards 30 to position the utility wildlife protector 20 in the closed retracted position.

The elongate installation tool 60 is preferably a “hot stick”, as understood by those skilled in the art. Although other elongate tools can be used as well, a hot stick is preferred because it is a standard article of equipment that is carried on most utility equipment trucks. It is further advantageous because installers I, i.e., utility linemen, are very familiar with the operation of a “hot stick.” Therefore, training costs can be substantially decreased. The “hot stick” can also advantageously be readily adapted so that it can be used by a lineman to engage a portion of the guard extender 50 during installation of the utility wildlife protector 20.

The elongate installation tool 60 is preferably insulated so as to prevent the flow of current if placed in contact with high voltage equipment 15, and to thereby advantageously reduce the risk of injury to the installer I. The elongate installation tool 60 preferably includes an installer handle 72 positioned on a proximal end 64 of the elongate installation tool 60. The installer handle 72 advantageously allows the installer I to readily rotate the elongate installation tool 60 in either the first L or second R predetermined directions.

As illustrated in FIG. 5, the wildlife guards 30 can include a smooth outer surface design. A smooth outer surface design advantageously decreases the probability of wildlife inhabiting portions of the wildlife guard 30. For example, birds prefer to build nests on wildlife guards by taking advantage of rough surfaces that do not have uniformity, such as surfaces having a rib-and-spoke design, as understood by those skilled in the art. A smooth outer surface design is intended to limit anchoring points for building of nests.

Each of the pair of wildlife guards 30 can advantageously have a semi-annular shape. The semi-annular shape advantageously decreases the space necessary to transport and store the wildlife guards 30, i.e., each of the semi-annular shaped wildlife guards 30 advantageously requires less area for storage and transport than a traditional circular wildlife guard. As previously noted, each one of the pair of wildlife guards 30 further preferably includes a plurality of openings 38 positioned thereon. The plurality of openings 38 can be circular in shape and can vary in size. The openings 38, however, can have any type of shape, as understood by those skilled in the art. Circular openings are more aesthetically pleasing, and therefore preferable. The plurality of openings 38 advantageously decrease environmental resistance encountered by an installed utility wildlife protector 20. For example, the plurality of openings 38 advantageously allow for wind and rain to pass through an installed utility wildlife protector 20 thereby decreasing forces applied to the utility wildlife protector 20 when installed.

The connector 40 of the utility wildlife protection system 10 is positioned to extend through at least one of the respective openings 38 positioned closely adjacent the respective first end portions 32 of each one of the pair of wildlife guards 30. The connector 40 is further positioned to pivotally connect the respective first end portions 32 of each one of the pair of wildlife guards 30 so that when the utility wildlife protector 20 is positioned in the open extended position, the respective first end portions 32 of the wildlife guards 30 are positioned closely adjacent one another and the respective second end portions 34 of the wildlife guards 30 are positioned substantially spaced-apart from one another. The connector 40 can advantageously be a bolt, for example, a bolt and nut combination, or any other device that can be positioned through at least one of the plurality of openings 38 of each of the pair of wildlife guards 30 to thereby connect the respective first end portions 32 of the wildlife guards 30 as understood by those skilled in the art.

The guard extender 50 of the utility wildlife protection system 10 can advantageously include an elongate threaded member 52 and a stationary receiving member. The elongate threaded member 52 preferably includes distal 53 and proximal 54 end portions.

The proximal end 54 of the elongate threaded member 52 preferably includes a guard extender adjuster adapter 59. The guard extender adjuster adapter 59 preferably includes a first end portion 58 that can be adapted to engage the guard extender-to-tool interface assembly 70 to open and close the utility wildlife protector 20 to the respective open extended and closed retracted positions. The first end portion 58 can advantageously include a shape that can be matingly connected to the guard extender-to-tool interface assembly 70. The first end portion 58 of the guard extender adjuster adapter 59 can also advantageously include a slot 90 formed therein for receiving a hook, for example, connected to portions of the guard extender-to-tool interface assembly 70. The distal end portion 53 of the elongate threaded member 52 is positioned to rotate in a first predetermined direction L to extend through the stationary receiving member 56. The rotation of the elongate threaded member 52 in the first predetermined direction L advantageously positions the utility wildlife protector 20 in the open extended position. The distal end 53 of the elongate threaded member 52 can also advantageously be adapted to rotate in a second predetermined direction R to retract through the stationary receiving member 56. The rotation of the elongate threaded member 52 in a second predetermined direction R advantageously positions the utility wildlife protector 20 in the closed retracted position. The elongate threaded member 52 can also advantageously be a bolt, for example, or any other elongate threaded member that can advantageously be adapted to rotate in first L and second R predetermined directions to position the utility wildlife protector 20 in the open extended or closed retracted positions as understood by those skilled in the art. The stationary receiving member 56 can advantageously be a nut, for example, or any other stationary member capable of receiving an elongate threaded member 52 and understood by those skilled in the art.

In the case of a utility wildlife protector 20 that is adapted for operation by two installers I, the utility wildlife protector 20 preferably includes a pair of guard extender adjuster adapters 59. Each of the pair of guard extender adjuster adapters 59 can advantageously include a second end portion 57 positioned substantially opposite the first end portion 58. The second end portion 57 of each of the guard extender adjuster adapters 59 can advantageously include a gear member 91. The pair of guard extender adjuster adapters 59 are preferably positioned perpendicular to each other so that during two-installer operation, the gear members 91 on each of the pair of guard extender adjuster adapters 59 are positioned to be engaged. During two installer operation, only one of the pair of guard extender adjuster adapters 59 is used to adjust the pair of wildlife guards 30 between the open and closed positions. This advantageously allows an installer I to approach and install the utility wildlife protector 20 from at least two different angles. This further advantageously allows for a second installer I to support the utility wildlife protector 20 while the first installer I can adjust the utility wildlife protector 20 between the open and closed positions. Although only two positions are shown in the drawings of the preferred embodiment, it will be understood by those skilled in the art that several different positions can be used by simply increasing the number of guard extender adjuster adapters 59. This advantageously decreases the burden of rotating portions of the utility wildlife guard 20 to the open extended and closed retracted positions.

The wildlife protection system 10 of the present invention advantageously allows one installer I to install a wildlife protector 20 when positioned a great distance from high voltage equipment 15, i.e., an installer I can advantageously be positioned at ground level when installing a utility wildlife protector 20 along elevated high voltage equipment 15, so as to reduce the risk of an installer I contacting high voltage equipment 15. This also advantageously decreases the time necessary to install the utility wildlife protector 20 and enhances the cost efficiency of installers I. The wildlife protection system 10 of the present invention also advantageously prevents wildlife from being harmed by eliminating the possibility of wildlife simultaneously contacting high voltage equipment 15 and an electrical ground. The wildlife protection system 10 of the present invention further advantageously allows for the installation of a utility wildlife protector 20 without interruption of electrical service.

As illustrated in FIG. 9, the guard extender 50 can be installed so as to allow for multiple directional access. This can be necessary, for example, if the utility wildlife protector 20 exceeds a particular size, thereby increasing the weight of the utility wildlife protector 20. In a case where the utility wildlife protector 20 has an increased weight that may be difficult for installation by one installer I, a pair of installers I can perform the installation. An auxiliary support portion 75 can be connected to the utility wildlife protector 20 so that a second installer I can support the weight of the utility wildlife protector 20 as the first installer I installs the utility wildlife protector 20, i.e., rotates the guard extender 50 in the first L and second R predetermined directions to position the utility wildlife protector 20 between the open extended position and closed retracted position. The second installer I can advantageously support the weight of the utility wildlife protector 20 by engaging the distal end portion 62 of an installation tool 60 with the auxiliary support portion 75 connected to the utility wildlife protector 20. The second installer I can advantageously support the utility wildlife protector 20 while the first installer I can advantageously rotate the guard extender 50 in the first L and second R predetermined directions. As illustrated in FIG. 8, a second installer I can also advantageously support the utility wildlife protector 20 during installation by engaging a distal end 62 of an elongate installation tool 60 with one of the plurality of openings 38 on the utility wildlife protector 20. The distal end 62 of the elongate installation tool 60 can be a hook, for example, that can be positioned to extend through the opening 38 in the utility wildlife protector 20. When the second installer I is supporting the weight of the utility wildlife protector 20, the first installer I can install the utility wildlife protector 20 using the same technique described above. This advantageously allows a large utility wildlife protector 20 having an excessive weight to be installed by a pair of installers I while maintaining a greater distance from high voltage equipment 15. This is also advantageous because the utility wildlife protector 20 can still be installed without interruption to electrical service.

The utility wildlife protector 20 can advantageously be engaged by the distal end 62 of the elongate installation tool 60 along either side of the utility wildlife protector 20, as illustrated in FIGS. 7, or along a surface portion of the utility wildlife protector 20, also as illustrated in FIG. 8. This advantageously provides increased maneuverability when installing the utility wildlife protector 20 depending on the location and configuration of the high voltage equipment 15 where the utility wildlife protector 20 is to be installed. For example, if the utility wildlife protectors 20 are to be installed at an awkward angle, it can be engaged by the distal end 62 of the elongate installation tool 60 to thereby simplify installation.

The utility wildlife protection system 10 of the present invention can also advantageously include connecting means for pivotally connecting the respective first end portions 32 of each of the pair of wildlife guards 30. The connecting means can advantageously be provided by a connector 40 positioned to extend through one of the plurality of openings 38 in each one of the pair of wildlife guards 30. As described above, the connector 40 can be a bolt, for example, positioned to join each of the pair of wildlife guards 20. The bolt can be passed through two of the plurality of opening 38, one opening on each of the pair of wildlife guards 30, to thereby form a pivoted connection between the pair of wildlife guards 30. The connecting means can also advantageously be provided by a hinged member having portions connected to each of the pair of wildlife guards 30. The hinged member advantageously allows the utility wildlife protector 20 to be positioned between the open extended position and the closed retracted position. The connecting means can still further advantageously be provided by a slide-bolt configuration. In the slide-bolt configuration, one of the pair of wildlife guards 30, can advantageously include a slide portion having a predetermined radius of rotation, and one of the pair of wildlife guards 30 can advantageously include a bolt portion that matingly engages the slide portion. The interaction between the slide and the bolt advantageously allows the utility wildlife protector 20 to be positioned between the open extended position and the closed retracted position.

As described in detail above, and as illustrated in FIG. 5, the present invention further includes the utility wildlife protector 20 for inhibiting wildlife from simultaneously contacting elevated high voltage equipment 15 and the electrical ground. The utility wildlife protector 20 of the present invention is preferably adapted to be positioned adjacent elevated high voltage equipment 15 and responsive to an elongate extension tool 60. The utility wildlife protector 20 of the present invention also advantageously includes an open extended position to allow inner peripheries 36 of the utility wildlife protector 20 to be positioned adjacent outer peripheries of the elevated high voltage equipment 15. The utility wildlife protector 20 of the present invention can also advantageously include a closed retracted position defined by the utility wildlife protector 20 substantially surrounding the outer peripheries of the elevated high voltage equipment 15. The utility wildlife protector 20 is respectively extended to an open extended position and retracted to a closed retracted position responsive to the movement of the elongate installation tool 60 by a user or an installer I. As described above, and as illustrated in FIG. 5, the utility wildlife protector 20 of the present invention further includes a pair of wildlife guards 30. Each of the pair of wildlife guards 30 include respective first 32 and second 34 opposing end portions. The wildlife guards 30 are preferably non conductive and have a semi-annular shape and a plurality of openings 38 to thereby decrease environmental resistance, i.e., wind resistance and rain resistance. As described above, the utility wildlife protector 20 further advantageously includes a connector 40 positioned to pivotally connect the pair of wildlife guards 30, and a guard extender 50 having an elongate threaded member 52 and a stationary receiving member 56.

The present invention further includes a method of inhibiting wildlife from simultaneously contacting high voltage equipment 15 and an electrical ground. The method preferably includes rotating portions of a guard extender 50 in a first predetermined direction L to pivotally open portions of the utility wildlife protector 20 to an open extended position to surround high voltage equipment 15, e.g., an insulator. The method further includes rotating portions of the guard extender 50 and a second predetermined direction R to pivotally close portions of the utility wildlife protector 20 to a closed retracted position. The method of inhibiting wildlife from simultaneously contacting high voltage equipment 15 and an electrical ground, also includes pivotally connecting a pair of wildlife guards 30 to thereby form the utility wildlife protector 20. The step of rotating portions of the guard extender 50 further includes rotating an elongate installation tool 60 that is matingly mounted to a guard extender 50. The method of inhibiting wildlife from simultaneously contacting high voltage equipment 15 and an electrical ground, still further includes elevating the utility wildlife protector 20 to an elevation substantially similar to the elevation of the high voltage equipment 15.

The present invention further advantageously includes a method of installing a utility wildlife protector 20 on elevated high voltage equipment 15 from ground level. The method advantageously includes rotating an elongate installation tool 60 in a first predetermined direction L when matingly mounted to the utility wildlife protector 20 to thereby position the utility wildlife protector 20 in an open extended position. The method also includes elevating the utility wildlife protector 20 to an elevation substantially similar to the elevation of the elevated high voltage equipment 15. The method of installing a utility wildlife protector 20 further includes rotating the elongate installation tool 60 in a second predetermined direction R when matingly mounted to the utility wildlife protector 20 to thereby position the utility wildlife protector 20 in a closed retracted position to surround the elevated high voltage equipment 15. The method further includes detaching the elongate installation tool 60 from the utility wildlife protector 20 after the utility wildlife protector 20 has been installed on the elevated high voltage equipment 15.

The present invention further includes methods of installing a utility wildlife protector 20 for preventing wildlife from simultaneously contacting high voltage equipment 15 and an electrical ground. The methods include the steps of engaging a portion of an elongate installation tool 60 with a portion of a guard extender 50 of a utility wildlife protector 20, turning the guard extender 50 in a first predetermined direction L to pivotally open the utility wildlife protector 20, positioning the utility wildlife protector 20 around high voltage equipment 15 so as to create a barrier between high voltage equipment 15 and an electrical ground, rotating the guard extender 50 in a second predetermined direction R to pivotally close a portion of the utility wildlife protector 20, and disengaging the elongate installation tool 60 from the guard extender 50 of the utility wildlife protector 20. The method also includes the step of pivotally connecting a pair of wildlife guards 30 with a connecter 40 to form a utility wildlife protector 20. The methods of the present invention advantageously allow one installer I to install the utility wildlife protector from a greater distance away from high voltage equipment 15, i.e., from ground level if the high voltage equipment 15 is elevated.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification.

That claimed is:

1. A utility wildlife protection system for inhibiting wildlife from simultaneously contacting high voltage equipment and an electrical ground, the wildlife protection system comprising:
a utility wildlife protector comprising a pair of wildlife guards each having respective first and second opposing end portions and each adapted to be positioned closely adjacent an insulator of high voltage equipment along opposing portions of inner peripheries thereof, the inner peripheries of the pair of wildlife guards positioned closely adjacent each other when the utility wildlife protector is positioned in a closed retracted position, a connector positioned to pivotally connect the respective first end portions of each of the pair of wildlife guards so that the respective second opposing end portions are positioned closely adjacent each other when the utility wildlife protector is positioned in the closed retracted position and are positioned substantially spaced apart from each other when the utility wildlife protector is positioned in an open extended position, and a guard extender connected closely adjacent the respective first end portions of each of the pair of wildlife guards for increasing and decreasing a distance between the respective second end portions of the pair of wildlife guards to thereby respectively position the utility wildlife protector between the open extended position and the closed retracted position; and
an elongate installation tool having a proximal and a distal end portion, the distal end portion including a guard extender adjuster adapted to abuttingly contact portions of the guard extender to responsively adjust the guard extender to thereby increase and decrease the distance between the respective second end portions of each of the pair of utility wildlife guards and respectively position the utility wildlife protector between the open extended position and the closed retracted position.

2. The utility wildlife protection system as defined in claim 1, wherein each one of the pair of wildlife guards are non-conductive, have a semi-annular shape and a plurality of openings to thereby decrease environmental resistence.

3. The utility wildlife protection system as defined in claim 2, wherein the connector is positioned to extend through at least one of the respective openings positioned closely adjacent the respective first end portions of each one of the pair of wildlife guards to thereby pivotally connect the respective first end portions of each one of the pair of wildlife guards.

4. The utility wildlife protection system as defined in claim 3, wherein the guard extender further comprises an elongate threaded member and a stationary receiving member, the elongate threaded member having distal and proximal end portions and positioned to rotate in a first predetermined direction to extend through the stationary receiving member to thereby position the utility wildlife protector in the open extended position and a second predetermined direction to retract through the stationary receiving member to thereby position the utility wildlife protector in the closed retracted position.

5. The utility wildlife protection system as defined in claim 4, wherein the guard extender adjuster matingly contacts the elongate threaded member of the guard extender to thereby rotate the guard extender in the first and second predetermined directions.

6. A utility wildlife protection system for inhibiting wildlife from simultaneously contacting high voltage equipment and an electrical ground, the wildlife protection system comprising:
a utility wildlife protector comprising a pair of wildlife guards, each having respective first and second opposing end portions and each adapted to be positioned closely adjacent an insulator of high voltage equipment along opposing portions of inner peripheries thereof, the inner peripheries of the pair of wildlife guards positioned closely adjacent each other when the utility wildlife protector is positioned in a closed retracted position, connecting means for pivotally connecting the respective first end portions of each of the pair of wildlife guards so that respective second opposing end portions are closely adjacent each other when the utility wildlife protector is positioned in the closed retracted position and are positioned substantially spaced apart from each other when the utility wildlife protector is positioned in an open extended position, and guard positioning means for positioning the utility wildlife protector between the open extended position and the closed retracted position, the guard positioning means positioned closely adjacent the respective first end portions of each of the pair of wildlife guards for increasing and decreasing the distance between the respective second end portions of the pair of wildlife guards to thereby respectively position the utility wildlife protector between the open extended position and the closed retracted position; and
an elongate installation tool having a proximal and a distal end portion, the distal end portion including guard adjusting means for adjusting the guard positioning means to increase and decrease the distance between the respective second ends of each of the pair of wildlife guards to thereby position the utility wildlife protector between the open extended position and the closed retracted position.

7. The utility wildlife protection system as defined in claim 6, wherein each one of the pair of wildlife guards are non-conductive, have a semi-annular shape and a plurality of openings to thereby decrease environmental resistance.

8. The utility wildlife protection system as defined in claim 7, wherein the connecting means is a connector positioned to extend through at least one of the respective openings positioned closely adjacent the respective first end portions of each one of the pair of wildlife guards to thereby pivotally connect the respective first end portions of each one of the pair of wildlife guards.

9. The utility wildlife protection system as defined in claim 8, wherein the guard positioning means further comprises an elongate threaded member and a stationary receiving member, the elongate threaded member having a distal and a proximal end portion and positioned to rotate in a first predetermined direction to extend through the stationary receiving member to thereby position the utility wildlife protector in the open extended position and a second predetermined direction to retract through the stationary receiving member to thereby position the utility wildlife protector in the closed retracted position.

10. The utility wildlife protection system as defined in claim 9, wherein the guard adjusting means matingly contacts the elongate threaded member of the guard positioning means to thereby rotate the guard positioning means in the first and second predetermined directions.

11. A utility wildlife protector for inhibiting wildlife from simultaneously contacting elevated high voltage equipment and an electrical ground, the utility wildlife protector adapted to be positioned adjacent elevated high voltage equipment and responsive to an elongate installation tool, the utility wildlife protector having an open extended position to allow inner peripheries of the utility wildlife protector to be positioned adjacent outer peripheries of the elevated high voltage equipment, and a closed retracted position defined by the utility wildlife protector substantially surrounding the outer peripheries of the elevated high voltage equipment, the utility wildlife protector being respectively extended to an open extended position and retracted to a closed retracted position responsive to movement of the elongate installation tool by a user.

12. The utility wildlife protector as defined in claim 11, further comprising a pair of wildlife guards each having respective first and second opposing end portions.

13. The utility wildlife protector as defined in claim 12, wherein each one of the pair of wildlife guards are non-conductive, have a semi-annular shape and a plurality of openings to thereby decrease environmental resistence.

14. The utility wildlife protector as defined in claim 13, further comprising a connector positioned to pivotally connect the respective first end portions of each of the pair of wildlife guards so that respective second opposing end portions are positioned closely adjacent each other when the utility wildlife protector is positioned in the closed retracted position and are positioned substantially spaced apart from each other when the utility wildlife protector is positioned in an open extended position.

15. The utility wildlife protector as defined in claim 14, further comprising a guard extender connected closely adjacent the respective first end portions of each of the pair of wildlife guards for increasing and decreasing a distance between the respective second end portions of the pair of wildlife guards to thereby 1respectively position the utility wildlife protector between the open extended position and the closed retracted position.

16. The utility wildlife protector as defined in claim 15, wherein the connector is positioned to extend through at least one of the respective openings positioned closely adjacent the respective first end portions of each one of the pair of wildlife guards to thereby pivotally connect the respective first end portions of each one of the pair of wildlife guards.

17. The utility wildlife protector as defined in claim 16, wherein the guard extender further comprises an elongate threaded member and a stationary receiving member, the elongate threaded member having distal and proximal end portions and positioned to rotate in a first predetermined direction to extend through the stationary receiving member to thereby position the utility wildlife protector in the open extended position and a second predetermined direction to retract through the stationary receiving member to thereby position the utility wildlife protector in the closed retracted position.

18. A method of inhibiting wildlife from simultaneously contacting high voltage equipment and an electrical ground, the method comprising:
rotating portions of a guard extender in a first predetermined direction to pivotally open portions of a utility wildlife protector to an open extended position to surround high voltage equipment; and
rotating portions of the guard extender in a second predetermined direction to pivotally close portions of the utility wildlife protector to a closed retracted position.

19. The method as defined in claim 18, further comprising pivotally connecting a pair of wildlife guards to thereby form the utility wildlife protector.

20. The method as defined in claim 19, wherein the step of rotating portions of the guard extender further comprise rotating an elongate installation tool that is matingly mounted to the guard extender.

21. The method as defined in claim 20, further comprising elevating the utility wildlife protector to an elevation substantially similar to the elevation of the high voltage equipment.

22. A method of installing a utility wildlife protector on elevated high voltage equipment from ground level, the method comprising:
rotating an elongate installation tool in a first predetermined direction when matingly mounted to the utility wildlife protector to thereby position the utility wildlife protector in an open extended position; and
elevating the utility wildlife protector to an elevation substantially similar to the elevation of the elevated high voltage equipment.

23. The method as defined in claim 22, further comprising rotating the elongate installation tool in a second predetermined direction when matingly mounted to the utility wildlife protector to thereby position the utility wildlife protector in a closed retracted position to surround the elevated high voltage equipment.

24. The method as defined in claim 23, further comprising detaching the elongate installation tool from the utility wildlife protector after the utility wildlife protector has been installed on the elevated high voltage equipment.
